(19) United States
(12) Patent Application Publication
(10) Pub. No.: US 2017/0106283 A1
(43) Pub. Date: Apr. 20, 2017

(54) AUTOMATED GENERATION OF GAME EVENT RECORDINGS

(71) Applicant: Microsoft Technology Licensing, LLC, Redmond, WA (US)

(72) Inventors: Michael William Malyuk, Redmond, WA (US); Robert L. Rodi, Kirkland, WA (US)

(21) Appl. No.: 14/885,860

(22) Filed: Oct. 16, 2015

(51) Int. Cl. A63F 13/49

(52) U.S. Cl. CPC A63F 13/49; A63F 2300/554; A63F 2300/634

(57) ABSTRACT

Game data representing a game event generated during gameplay of a video game on a client computing device is received from the client computing device. The game data is provided as input to a machine-learning analyzer to determine whether the game event is an event of interest. The machine-learning analyzer is previously-trained using previously-recorded game events deemed popular based on community feedback. The machine-learning analyzer determines that the game event is an event of interest based on the game event having characteristics that match characteristics of the previously-recorded game events deemed popular. A command to generate a recording of the game event is issued in response to the machine-learning analyzer determining that the game event is an event of interest.

### BACKGROUND

A computing device may provide video game recording functionality. A video game recording may be used in various ways. For example, the recording may be stored locally on the computing device, and the computing device may visually present the recording at a time subsequent to capture of the recording. In another example, the computing device may upload the recording to one or more remote computing devices for visual presentation to other users at a time subsequent to capture of the recording.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Game data representing a game event generated during gameplay of a video game on a client computing device is received from the client computing device. The game data is provided as input to a machine-learning analyzer to determine whether the game event is an event of interest. The machine-learning analyzer is previously-trained using previously-recorded game events deemed popular based on community feedback. The machine-learning analyzer determines that the game event is an event of interest based on the game event having characteristics that match characteristics of the previously-recorded game events deemed popular. A command to generate a recording of the game event is issued in response to the machine-learning analyzer determining that the game event is an event of interest.

### BRIEF DESCRIPTION OF THE DRAWINGS

FIG. 1 shows an example computing environment.

FIG. 2 shows an example gameplay perspective of an example game event visually presented during gameplay of an example video game.

FIG. 3 shows an example recording perspective of the game event of FIG. 2.

FIG. 4 shows an example gameplay perspective of another example game event visually presented during gameplay of another example video game.

FIG. 5 shows an example recording perspective of the game event of FIG. 4.

FIG. 6 shows an example method for recording a game event.

FIG. 7 shows an example computing system.

### DETAILED DESCRIPTION

A gameplay clip or segment generated during the course of gameplay of a video game may be manually recorded by a user. For example, the user may provide a voice command to initiate recording of a gameplay clip. In another example, the user may manipulate a control of a user input device (e.g., press a button on a game controller) to initiated recording of a gameplay clip. However, the manual nature of these approaches requires the user to disengage momentarily from playing the video game to ensure a recording is generated. Such disengagement may break immersion of the user from within a gameplay experience. Furthermore, a user may decide to record gameplay clips that are not interesting to others, or miss recording clips that would be interesting to others.

Accordingly, this description relates to automatically and intelligently recording game events that occur during the course of video game gameplay. The intelligent selection of game events may be offloaded from individual client computing devices to a service computing system. In particular, the service computing system may include a machine-learning analyzer tuned to the interests of a larger community. The machine-learning analyzer may determine that a game event is an event of interest based on the game event having characteristics that match characteristics of previously-recorded game events that are deemed popular by the community.

For example, if a previously recorded and published game clip has been viewed above a threshold number of times (e.g., 10,000 views), the machine-learning analyzer may identify the game event embodied in the game clip as a game event of interest. Further, the machine-learning analyzer may automatically recognize characteristics of the game event of interest that are relatively unusual when compared to all similar game clips. In essence, the machine-learning analyzer uses popularity to determine which unusual characteristics of a game event are interesting to the community. As an example, a popular game clip of a first-person shooter may have a kill shot that ricochets three times prior to dropping a target. By considering the game clip in the context of all game clips, the machine-learning analyzer may determine that the three-ricochet kill shot is highly unusual and likely the factor contributing to the clip's popularity. As such, the machine-learning analyzer may consider other clips having high-ricochet kill shots as being of potential interest to the community.

By automatically generating recordings of game events deemed interesting, a user may remain immersed in a gameplay experience of a video game while at the same time collecting recordings of interesting game events that may be subsequently viewed and/or shared with other members of the community.

Furthermore, in some implementations, the machine-learning analyzer may be re-trained as new recordings of game events that are deemed interesting become available. In other words, a feedback loop may be created that can be leveraged to continue refining the machine-learning analyzer according to the changing preferences of the community.

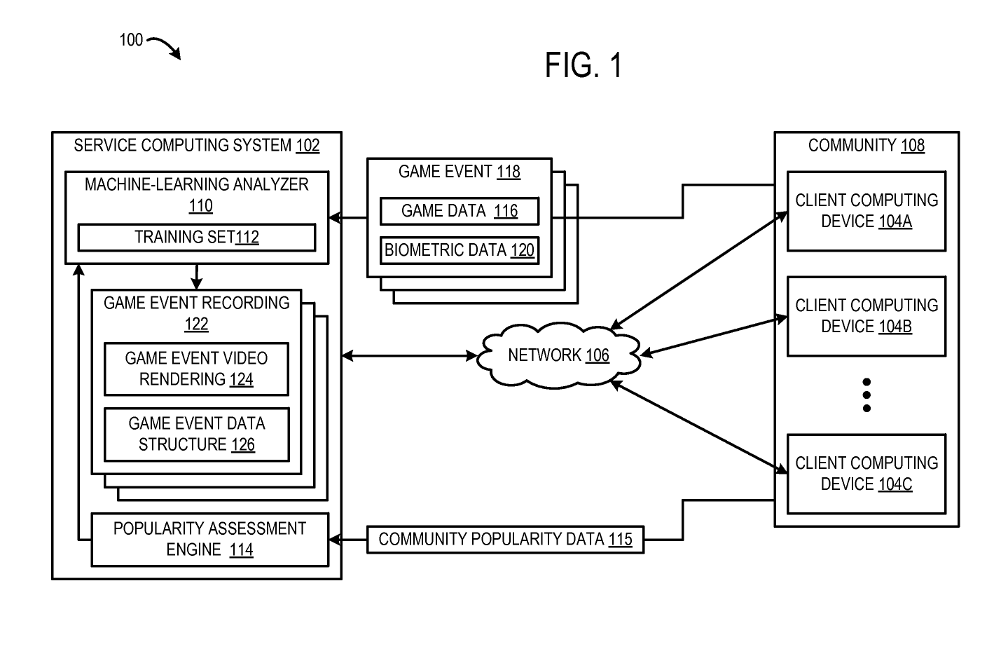

FIG. 1 shows a computing environment 100 including a service computing system 102 configured to communicate with a plurality of client computing devices 104 (e.g., 104A, 104B, 104C) via a network 106, such as the Internet. The plurality of client computing devices 104 may take any suitable form. For example, the plurality of client computing devices 104 may take the form of one or more personal computers, tablet computers, home-entertainment computers, augmented or virtual reality computers, network computing devices, gaming devices, mobile computing devices, mobile communication devices (e.g., smart phone), and/or other computing devices.

In the illustrated implementation, the plurality of client computing devices 104 may take the form of gaming devices configured to execute different video games. In some implementations, the video games may be principally executed on the client computing devices 104, as opposed to a platform or server-based game that may be hosted on a server computing machine and merely accessed at a client computing device, such as via a web browser. In other implementations, the video games may be network games that are primarily remotely-executed but with input/output duties performed by the client computing devices.

The plurality of client computing devices 104 may be used within a community 108 in which various members interact with one another by playing video games, having video game related interactions (e.g., chat, forum, group message), consuming video game related content, and having other social interactions unrelated to video games.

The service computing system 102 may be configured to track actions and events that are generated during gameplay (or game execution) of a video game on each of the plurality of client computing devices 104. In particular, the service computing system 102 may track game events in order to determine whether a game event is an event of interest, in which case a recording of the game event may be generated. In other words, the service computing system 102 may handle game event processing in order to provide and/or control gameplay recording functionality on behalf of the plurality of client computing devices 104.

The service computing system 102 may include a machine-learning analyzer 110 configured to determine whether a game event is an event of interest. The machine-learning analyzer 110 may be previously-trained using a training set 112 including numerous different previously-recorded game events of a video game. Each previously-recorded game event may have a set of characteristics derived from game data of the game event. The training set 112 may include previously-recorded game events that are deemed popular and previously-recorded game events that are deemed not popular based on feedback from the community 108.

The service computing system 102 may include a popularity assessment engine 114 configured to track the popularity of game event recordings provided to the community 108. In particular, the popularity assessment engine 114 may receive and/or derive, for each game event recording, community popularity data 115, and may deem that the game event recording is popular based on the community popularity data 115.

The popularity assessment engine 114 may deem a game event recording to be popular in any suitable manner. In one example, a game event recording is deemed popular in response to exceeding a community popularity threshold. For example, the community popularity threshold may include a threshold number of times a game event recording is viewed by members of the community 108. In another example, the community popularity threshold may include a threshold number of affirmations (e.g., “likes”) of a game event recording by members of the community 108. In yet another example, the community popularity threshold may include a threshold number of recommendations of a game event recording by members of the community 108.

The popularity assessment engine 114 may provide to the machine-learning analyzer 110 an assessment of popularity and/or other popularity information for each game event recording included in the training set 112. The machine-learning analyzer 110 may use the popularity assessment and other information for training purposes as will be discussed in further detail below. In some instances, the popularity data may be included as part of the game event 118.

In some implementations, the popularity assessment engine 114 may be configured to track popularity of a game event over time. Accordingly, the machine-learning analyzer 110 may determine which game event recordings are recently popular in order to accurately reflect the current interests of the community 108.

The previously-recorded game events that are deemed popular may have characteristics that may be uncommon or distinctive relative to characteristics of other previously-recorded game events (e.g., not popular game events) in the training set 112. As such, during the training process, the machine-learning analyzer 110 may develop a profile of characteristics that may be used to recognize and/or predict other game events that may be interesting or popular with the community 108. In particular, the machine-learning analyzer 110 may be trained to determine that a game event is an event of interest based on the game event having characteristics that match characteristics of the previously-recorded game events deemed popular or of interest by the community 108. In some implementations, characteristics may be determined to be matching based on meeting designated matching criteria, such as exceeding one or more thresholds. For example, if a popular game event includes a three-ricochet kill shot, then the matching criteria may specify that any game event in which three or more ricochets occur prior to a kill shot may have matching characteristics. Accordingly, in this example, a game event including a six-ricochet head shot may be determined to match a game event including a three-ricochet head shot. The machine-learning analyzer 110 may recognize any suitable characteristic of a game event. Moreover, the machine-learning analyzer 110 may match any suitable number of characteristics to determine that a game event is an event of interest.

The machine-learning analyzer 110 may be trained in any suitable manner. In some implementations, the machine-learning analyzer 110 may be trained in an automated manner in which characteristics of the previously-recorded game events that contribute to popularity can be automatically determined based on the rarity of the characteristics among all game events being considered. Alternatively, the machine-learning analyzer 110 may be trained via supervised learning in which a human trainer identifies characteristics of game events that contribute to popularity. In some implementations, the machine-learning analyzer 110 may be trained to identify game events without consideration for community feedback. In one example, the machine-learning analyzer 110 may be trained to determine that unique or rarely occurring game events are events of interest without initial consideration for community feedback. In other words, the machine-learning analyzer 110 may be trained to provide “educated guesses” at what might be interesting to the community 108. Further, the machine-learning analyzer 110 may be configured to analyze community popularity data 115 related to the speculated events of interest in order to validate or invalidate whether the speculated events are actually popular with the community 108. The machine-learning analyzer 110 may be retrained using the community feedback to tune the characteristics for determining future events of interest. By training the machine-learning analyzer 110 in such a manner, the machine-learning analyzer 110 can identify game events that may be of interest to the community 108, but have not been previously identified by the community 108 as being interesting or popular. The machine-learning analyzer 110 may determine that a game event is an event of interest based on any suitable characteristics and/or factors. The machine-learning analyzer 110 may be configured according to any suitable machine-learning approach including, but not limited to, decision-tree learning, artificial neural networks, support vector machines, and clustering.

In some implementations, the training set 112 may include biometric data of game players collected during generation of previously-recorded game events of the training set 112. The biometric data may be used to train the machine-learning analyzer 110 to recognize biometric characteristics of game players. Further, the machine-learning analyzer 110 may use the biometric data included in the training set 112 to develop a profile of biometric characteristics that may be used at least in part to recognize and/or predict other game events that may be interesting or popular with the community 108. For example, a game player may react to an interesting game event in a particular manner that can be identified based on particular biometric characteristics demonstrated by the game player.

The machine-learning analyzer 110 may recognize any suitable biometric characteristic of a game player. Non-limiting examples of biometric characteristics of a game player that may indicate interest in a game event may include motion, a volume of her/his voice, a pulse rate, a blood pressure level, a pupil size, and a galvanic skin response. For example, such biometric data may be collected by one or more sensors for game players that opt-in to having biometric data collected during gameplay.

In some implementations, a different machine-learning analyzer may be trained for each different video game, and each different machine-learning analyzer may be trained to recognize and compare a different set of characteristics that are specific to the particular video game or type of video game. For example, a baseball video game and a first-person-shooter video game may utilize different characteristics for defining a game event of interest.

In some implementations, the machine-learning analyzer 110 may be re-trained based on changing preferences of the community 108. For example, the machine-learning analyzer 110 may be re-trained to recognize that an event of interest is defined by a different set of characteristics based on different previously-recorded game events becoming popular. The machine-learning analyzer 110 may be re-trained in any suitable manner. In one example, the machine-learning analyzer 110 may be re-trained in accordance with a designated period. In another example, the machine-learning analyzer 110 may be re-trained responsive to a threshold number of game events being deemed popular by the community 108 since the last time the machine-learning analyzer 110 was trained. In another example, the machine-learning analyzer 110 may be re-trained responsive to a threshold number of game events being analyzed by the machine-learning analyzer 110 since the last time the machine-learning analyzer 110 was trained.

The service computing system 102 may be configured to process game data 116 representing a game event 118 by providing the game data 116 as input to the machine-learning analyzer 110. In one example, during gameplay of a video game executed by the client computing device 104A, the client computing device 104A may send game data 116 to the service computing system 102. For example, the client computing device 104A may send the game data 116 to the service computing system 102 substantially in real-time (e.g., as the game is being played). As another example, game data can be sent after a gaming session is completed. Each of the plurality of computing devices 104 may send game data 116 to the service computing system 102 as described above.

The game data 116 may include any suitable information representative of, or otherwise associated with a video game. In one example, the game data 116 may include a data stream of lower-level game state information. The lower-level game state information may holistically define a state of a video game. The data stream of lower-level game state information may be suitable for recreating gameplay of the video game (e.g., generating a rendering of the gameplay). The game data further may include a data stream of higher-level game event information. The higher-level game event information may provide a description of particular game events, but may not holistically define a state of the video game. In general, game data may include every variable or other parameter tracked by a game and used to render game visuals. Non-limiting examples of game data may include, but are not limited to, game variables associated with playable/non-playable characters and associated characteristics (e.g., physical traits, skill levels), character associations (e.g., teams, clans, races, species), virtual objects of interaction (e.g., equipment, weapons, vehicles), virtual environment (e.g., location, setting, environmental conditions, lighting conditions, structures, game levels, quests, jobs), and timing (e.g., date, time of day, time left in game/session/round).

In some implementations, the service computing system 102 may be configured to receive biometric data 120 of a game player of the video game. The biometric data 120 may be captured during generation of the game event during gameplay of the video game. The service computing system 102 may provide the biometric data 120 as input to the machine-learning analyzer 110 to determine whether the game event is an event of interest.

The service computing system 102 may be configured to issue a command to generate a recording of the game event in response to the machine-learning analyzer 110 determining that the game event is an event of interest. In one example, the command may be issued to a rendering engine of the service computing system 102. In another example, the command may be issued to a rendering engine of a remote computing device, such as a third-party rendering service computing system. In another example, the command may be issued to a particular client computing device at which the game event was generated during gameplay. For example, the client computing device 104A may include a ring buffer that records a duration (e.g., five minutes) of gameplay, and the recording 122 may be generated directly from the currently loaded ring buffer.

The game event recording 122 may be generated at any suitable time after the machine-learning analyzer 110 determines that the game event is an event of interest. In one example, the recording 122 may be generated during or temporally proximate to generation of the game event. For example, in the case of the recording being generated by the client computing device 104A, the recording 122 may be generated at a time when the gameplay is stored in the ring buffer. In another example, the recording 122 may be generated at a substantially later time.

In some implementations, all game events (e.g., game events of interest and game events not of interest) generated by the plurality of client computing devices 104 over a designated duration may be stored at the service computing system 102 so that the game events may be provided to the machine-learning analyzer 110 as the machine-learning analyzer 110 is re-trained. Accordingly, game events may be determined to be events of interest in a retroactive manner as interests of the community 108 change.

The game event recording 122 may take any suitable form. In one example, the recording 122 of the game event of interest may include a video rendering 124 (e.g., a video file) of the game event of interest. The video rendering 124 may be suitable for presentation at a computing device without additional processing

In another example, the recording 122 of the game event of interest may include a game event data structure 126 including relevant game data generated at the client computing device 104A during gameplay. The game event data structure 126 may include suitable game data (e.g., game state, game variables) to allow the service computing system 102 (or another computing system) to generate the video rendering 124.

In some implementations, the service computing system 102 may be configured to send a command to the client computing device 104A to provide an in-game reward in response to the game event being determined to be an event of interest. Non-limiting examples of in-game rewards may include virtual articles of clothing, virtual weapons, virtual currency, unlocking playable game levels, unlocking playable teams, badges, rankings, and other virtual object within the video game. Rewards may additionally or alternatively be rewarded out of the game. By providing rewards for generating game events of interest, members of the community may be incentivized to generate additional recordings to share with the community.

In some implementations, the service computing system 102 may be configured to generate the recording 122 of the game event from a perspective different than an original perspective presented during gameplay of the video game on the client computing device 104A. In some implementations, the service computing system 102 may change a perspective of the recording to highlight the event of interest. The service computing system 102 may change the perspective of the recording in any suitable manner. In some implementations, the service computing system 102 may change the perspective in an automated manner. In one example, the service computing system 102 may change the perspective based on the particular characteristics of the game event of interest that trigger generation of the recording. For example, if a multi-ricochet kill shot is determined to be an event of interest due to the multi-ricochet characteristics, then the perspective may be changed to highlight the multiple ricochets.

In another example, service computing system 102 may change the perspective in a pseudo automated manner in which a plurality of different blueprints may be predefined for making recordings based on different scenarios. For example, the service computing system 102 may recognize that there are a lot of different types of kills in a first-person-shooter game that may lead to interest, and in all cases, the recording perspective may follow a blueprint in which the object that causes the kill is followed in slow motion until the object kills the victim. In another example, all close proximity kills of interest may follow a blueprint that specifies switching to a third-person view that shows both the killer and the victim.

The service computing system 102 may change a gameplay perspective to a different recording perspective in any suitable manner. In one example, the gameplay perspective of the game event may be a first person perspective of a virtual environment, and the recording perspective may be a third-person perspective of the virtual environment. In another example, the gameplay perspective may be a first virtual camera angle of a virtual environment, and the recording perspective may be a second camera angle of the virtual environment different than the first camera angle. In another example, the gameplay perspective may follow a virtual avatar of a game player throughout a virtual environment, and the recording perspective may follow an object of interest throughout the virtual environment. In some implementations, the recording may include a plurality of different perspectives that highlight the game event. For example, the recording may include a montage of different camera angles.

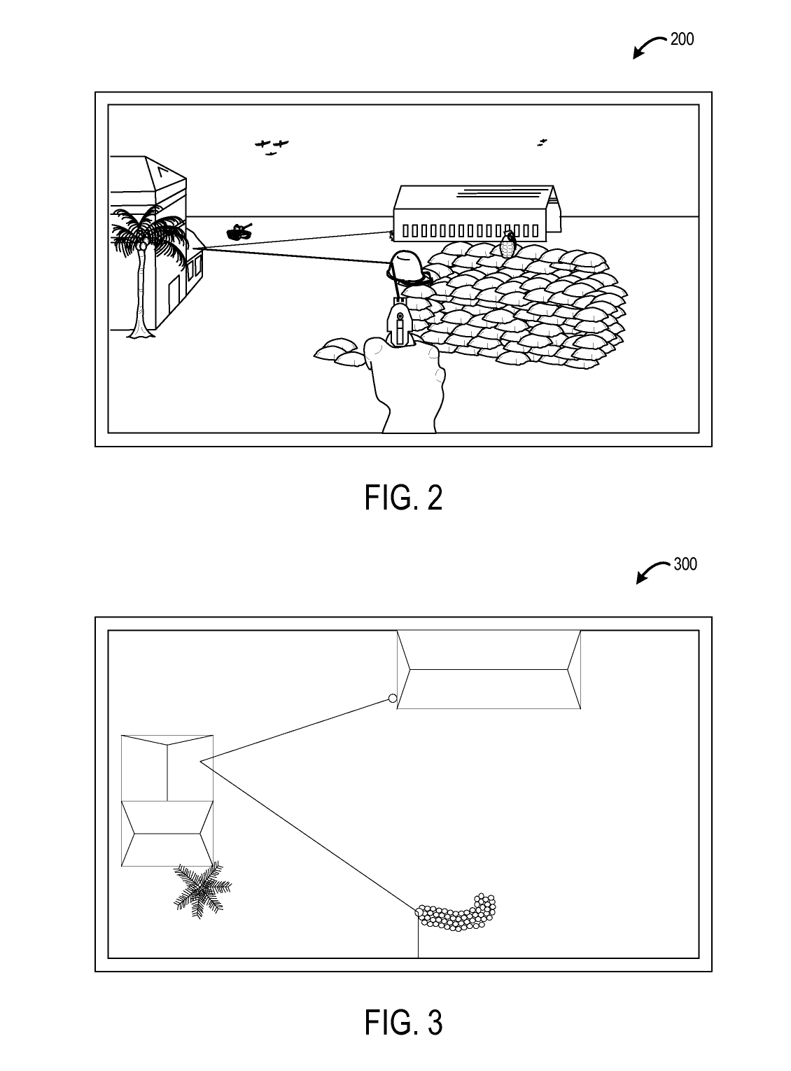

FIGS. 2-5 show different example game events having different gameplay and recording perspectives. FIG. 2-3 show an example game event that takes place in a virtual environment of a shooter-style video game. In particular, the game event includes a playable virtual character shooting a bullet that first ricochets off of a helmet and then ricochets again off of a roof top before hitting another virtual character hiding behind a far-off building. Such an event may occur rarely throughout the course of gameplay and may be difficult to re-create. As such, the machine-learning analyzer 110 may have previously been trained to recognize multi-ricochet and/or turn-the-corner kill shots as event characteristics that are popular within the community. Accordingly, the service computing system 102 may generate a recording of the game event.

FIG. 2 shows a gameplay perspective 200 of the game event. The gameplay perspective 200 may be the perspective of the video game that is visually presented during gameplay of the video game. In this particular example, the gameplay perspective 200 is a first-person perspective of the playable virtual character that is controlled by a player of the video game.

FIG. 3 shows an example recording perspective 300 of the game event that differs from the gameplay perspective 200 shown in FIG. 2. The recording perspective 300 may be the perspective of the video game that is visually presented in the recording of the game event. In particular, the recording perspective 300 shows an overhead view of the virtual environment that allows the entire path of the bullet to be traced from the gun, to the helmet, to the roof top, and finally to the other virtual character. In this example, the gameplay perspective 200 may not necessarily allow a viewer to see the path of the bullet with enough detail to appreciate how amazing it is for the bullet to hit the other virtual character in such a manner. Accordingly, in the recording, the perspective may be changed to the recording perspective 300 in order to highlight the game event. In other examples, the recording perspective may have a different perspective. For example, the recording perspective may include a third-person perspective that follows the bullet in slow motion. In another example, the recording perspective may include a first person perspective of the virtual character that is hit by the bullet.

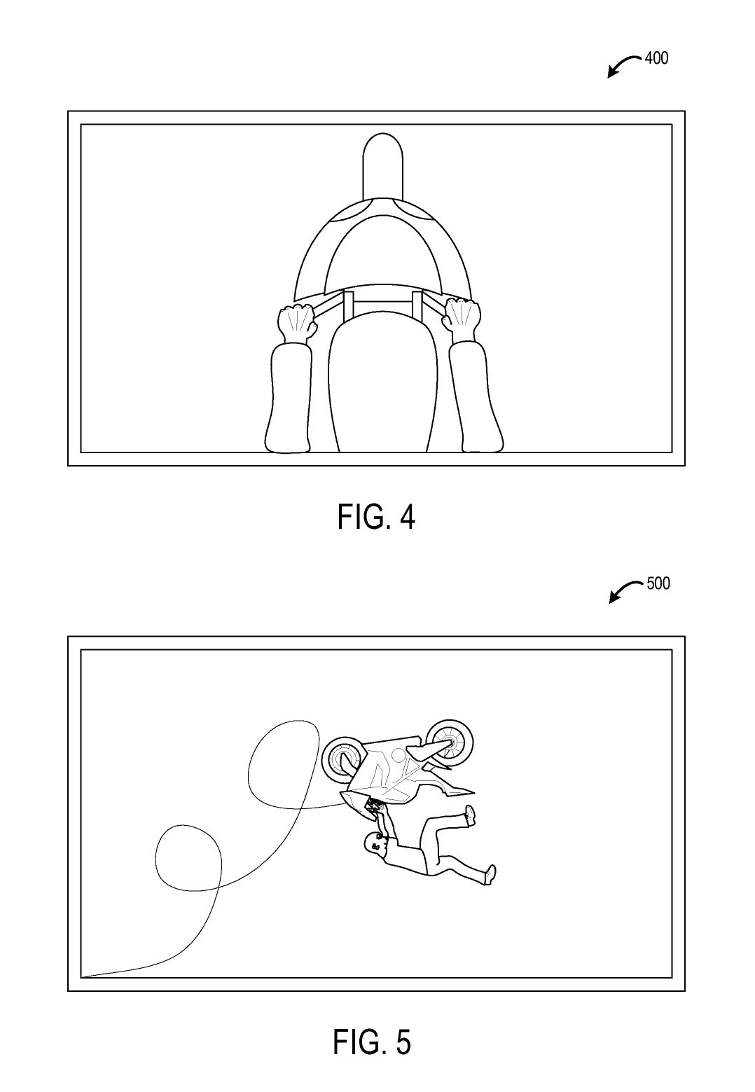

FIGS. 4-5 show another example game event that takes play in a virtual environment of a motorcycle racing video game. In particular, the game event includes a playable virtual character performing a triple backflip on a motorcycle. Such an event may occur rarely throughout the course of gameplay and may be difficult to re-create. As such, the machine-learning analyzer 110 may have previously been trained to recognize multiple backflips as event characteristics that are popular within the community. Accordingly, the service computing system 102 may generate a recording of the game event.

FIG. 4 shows a gameplay perspective 400 of the game event. The gameplay perspective 400 may be the perspective of the video game that is visually presented during gameplay of the video game. In this particular example, the gameplay perspective 400 is a first-person perspective of the playable virtual character that shows a view of the front of the motorcycle where the character holds onto the handle bars.

FIG. 5 shows an example recording perspective 500 of the game event that differs from the gameplay perspective 400 shown in FIG. 4. The recording perspective 500 may be the perspective of the video game that is visually presented in the recording of the game event. In particular, the recording perspective 500 shows a third-person perspective of the playable virtual character riding the motorcycle. In this example, the gameplay perspective 400 may not necessarily allow a viewer to see the motion of the entire motorcycle with enough detail to appreciate how amazing it is for the motorcycle to do a triple backflip. Accordingly, in the recording, the perspective may be changed to the recording perspective 300 in order to highlight the game event.

Continuing with FIG. 1, the recording 122 may be used by the service computing system 102 in various manners. For example, the service computing system 102 may allow the recording 122 to be accessed and/or presented to various client computing devices 104 in the community 108. The recording 122 may be presented to the community 108 in any suitable manner. In one example, the recording 122 may be presented via a video portal dedicated to recordings of game events generated during gameplay of the particular video game by different members of the community 108. In another example, the recording 122 may be presented via a virtual marketplace in which the particular video game is sold in order to help persuade a shopper to purchase the video game.

Furthermore, the service computing system 102 may receive feedback in the form of community popularity data 115 from the community 108 based on viewing of the recording 122. The popularity assessment engine 114 may analyze the community popularity data 115 to determine whether the recording 122 is an event of interest or popular with the community 108.

In some implementations, the recording 122 may be used to re-train the machine-learning analyzer 110 based on the recording 122 being deemed popular in the community 108 by the popularity assessment engine 114. For example, the recording 122 may be included in a set of game event recordings (popular or otherwise) that may be used to re-train the machine-learning analyzer 110. The machine-learning analyzer 110 may be re-trained in any suitable manner based on feedback from the community 108. As such, the machine-learning analyzer 110 may be continuously tuned to the changing preferences of the community 108.

Although client computing device 104A is repeatedly referenced in the above described examples, the service computing system 102 may interact with any of the plurality of client computing devices 104 in the same manner.

The configurations described above may enable various methods for intelligently generating a recording of a game event in an automated manner. Accordingly, some such methods are now described, by way of example, with continued reference to the above configurations. It is to be understood, however, that these methods, and others fully within the scope of the present disclosure, may be enabled via other configurations as well.

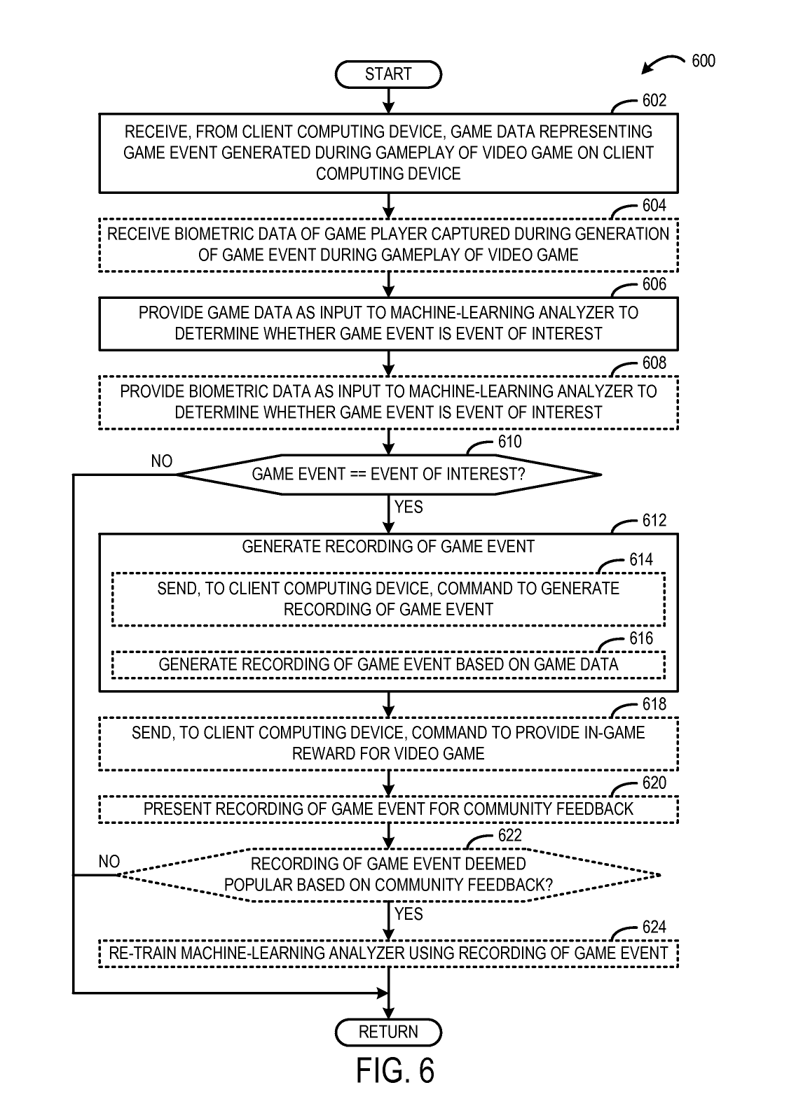

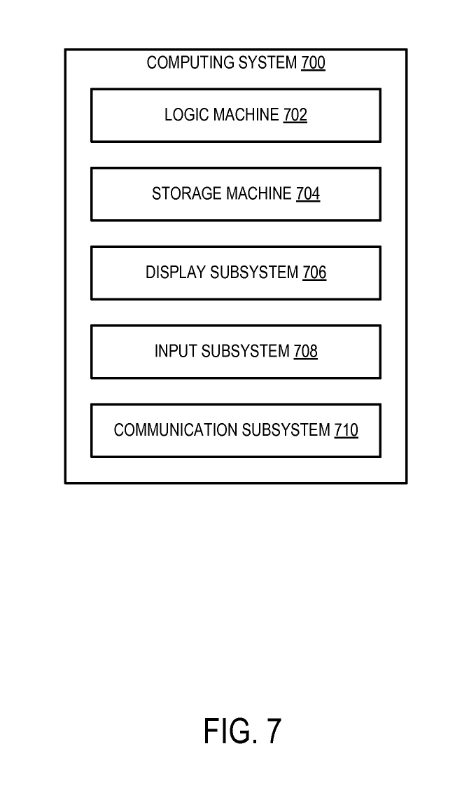

FIG. 6 shows an example method 600 for recording a game event. In one example, the method 600 may be performed by the service computing system 102 shown in FIG. 1. In another example, the method 600 may be performed by the computing system 700 shown in FIG. 7.

At 602, the method 600 may include receiving, from a client computing device, game data representing a game event generated during gameplay of a video game on the client computing device.

In some implementations, at 604, the method 600 optionally may include receiving biometric data of a game player of the video game. The biometric data may be captured during generation of the game event during gameplay of the video game.

At 606, the method 600 may include providing the game data representing the game event as input to a machine-learning analyzer to determine whether the game event is an event of interest. The machine-learning analyzer may be previously-trained using at least previously-recorded game events deemed popular based on community feedback.

In some implementations, at 608, the method 600 optionally may include providing the biometric data as input to the machine-learning analyzer to determine whether the game event is an event of interest. In some such implementations, the machine-learning analyzer may be previously-trained using biometric data of game players during generation of previously-recorded game events deemed popular based on community feedback.

At 610, the method 600 may include determining whether the game event is an event of interest. In one example, the machine-learning analyzer may determine that the game event is an event of interest based on the game event having characteristics that match characteristics of the previously-recorded game events. In some implementations, the machine-learning analyzer may determine that the game event is an event of interest based on the game event having characteristics that match characteristics of previously-recorded game events deemed popular based on community feedback. In some implementations, the machine-learning analyzer may determine that the game event is an event of interest, because the characteristics of the game event indicate that the game event is unique or rare. In another example, the machine-learning analyzer may determine that the game event is an event of interest based on the game player having biometric characteristics that match biometric characteristics of the game players during generation of the previously-recorded game events. If the game event is deemed an event of interest, then the method 600 moves to 612. Otherwise, the method 600 returns to other operations.

At 612, the method 600 may include generating a recording of the game event in response to the machine-learning analyzer determining that the game event is an event of interest. In one example, at 614, generating optionally may include sending, to the client computing device, a command to generate a recording of the game event. In another example, at 616, generating optionally may include generating a recording of the game event based on game data received from the client computing device. In one example, such game data may be received from the client computing device during gameplay of the video game. In another example, such game data may be received responsive to a request sent after the game event was determined to be an event of interest.

In some implementations, at 618, the method 600 optionally may include sending, to the client computing device, a command to provide an in-game reward for the video game in response to the game event being determined to be an event of interest.

In some implementations, at 620, the method 600 optionally may include presenting the recording of the game event for community feedback.

In some implementations at 622, the method 600 optionally may include determining whether the recording of the game event is deemed popular based on the community feedback. If the recording is deemed popular based on the community feedback, then the method 600 moves to 624. Otherwise, the method 600 returns to other operations.

In some implementations, at 624, the method 600 optionally may include re-training the machine-learning analyzer using the recording of the game event in response to the recording of the game event being deemed popular based on community feedback. In some implementations, the method 600 optionally may include re-training the machine-learning analyzer using the recording of the game event in response to the recording of the game event being deemed not popular based on community feedback.

By handling processing of game events and automatically generating recordings of game events deemed interesting or popular, a burden of manually recording game event may be removed from a user during gameplay. Accordingly, the user may remain immersed in a gameplay experience while at the same time collecting recordings of interesting game events that may be subsequently viewed and/or shared with other members of the community.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices. The computing system 700 may represent the service computing system 102 and/or the plurality of client computing devices 104 shown in FIG. 1.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine 702 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 702 may include one or more processors configured to execute software instructions. Additionally or alternatively, the logic machine 702 may include one or more hardware or firmware logic machines configured to execute hardware or firmware instructions. Processors of the logic machine 702 may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine 702 may be virtualized and executed by remotely accessible, networked computing devices configured in a cloud-computing configuration.

Storage machine 704 includes one or more physical devices configured to hold instructions executable by the logic machine 702 to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “engine” may be used to describe an aspect of computing system 700 implemented to perform a particular function. In some cases, an engine may be instantiated via logic machine 702 executing instructions held by storage machine 704. It will be understood that different engines may be instantiated from the same application, service, code block, object, library, routine, API, function, etc. Likewise, the same engine may be instantiated by different applications, services, code blocks, objects, routines, APIs, functions, etc. The terms “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine 704, and thus transform the state of the storage machine 704, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some implementations, the input subsystem 708 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem 710 may be configured for communication via a wireless telephone network, or a wired or wireless local- or wide-area network. In some implementations, the communication subsystem 710 may allow computing system 700 to send and/or receive messages to and/or from other devices via a network such as the Internet.

In another example implementation, on a service computing system, a method for recording a game event includes receiving, from a client computing device, game data representing a game event generated during gameplay of a video game on the client computing device, providing the game data as input to a machine-learning analyzer to determine whether the game event is an event of interest, the machine-learning analyzer previously-trained using previously-recorded game events deemed popular based on community feedback, the machine-learning analyzer determining that the game event is an event of interest based on the game event having characteristics that match characteristics of the previously-recorded game events deemed popular, and issuing a command to generate a recording of the game event in response to the machine-learning analyzer determining that the game event is an event of interest. In one example implementation that optionally may be combined with any of the features described herein, the machine-learning analyzer is previously trained using previously-recorded game events deemed not popular based on community feedback. In one example implementation that optionally may be combined with any of the features described herein, a previously-recorded game event is deemed popular in response to the previously-recorded game event exceeding a community popularity threshold. In one example implementation that optionally may be combined with any of the features described herein, the community popularity threshold includes a threshold number of times a recording of the previously-recorded game event is viewed by community members. In one example implementation that optionally may be combined with any of the features described herein, the community popularity threshold includes a threshold number of affirmations of a recording of the previously-recorded game event by community members. In one example implementation that optionally may be combined with any of the features described herein, the community popularity threshold includes a threshold number of recommendations of a recording of the previously-recorded game event by community members. In one example implementation that optionally may be combined with any of the features described herein, the method further includes presenting the recording of the game event for community feedback, and re-training the machine-learning analyzer using the game event in response to the recording of the game event being deemed popular based on community feedback. In one example implementation that optionally may be combined with any of the features described herein, the method further includes sending, to the client computing device, a command to provide a reward in response to the recording of the game event being determined to be an event of interest. In one example implementation that optionally may be combined with any of the features described herein, the method further includes receiving biometric data of a game player of the video game, the biometric data captured during generation of the game event during gameplay of the video game and providing the biometric data as input to the machine-learning analyzer to determine whether the game event is an event of interest. The machine-learning analyzer is previously-trained using biometric data of game players during generation of previously-recorded game events. The machine-learning analyzer determines that the game event is an event of interest based on the game player having biometric characteristics that match biometric characteristics of game players during generation of the previously-recorded game events.

In another example implementation, a service computing system, includes a logic machine, and a storage machine holding instructions executable by the logic machine to: receive, from a client computing device, game data representing a game event generated during gameplay of a video game on the client computing device, the game event visually presented from a first perspective during gameplay of the video game on the client computing device, provide the game data as input to a machine-learning analyzer to determine whether the game event is an event of interest, and generate a recording of the game event based on the game data in response to the machine-learning analyzer determining that the game event is an event of interest, the recording of the game event having a second perspective different than the first perspective. In one example implementation that optionally may be combined with any of the features described herein, the machine-learning analyzer is previously-trained using previously-recorded game events deemed popular based on community feedback, and the machine-learning analyzer is configured to determine that the game event is an event of interest based on the game event having characteristics that match characteristics of the previously-recorded game events deemed popular. In one example implementation that optionally may be combined with any of the features described herein, a previously-recorded game event is deemed popular in response to the previously-recorded game event exceeding a community popularity threshold. In one example implementation that optionally may be combined with any of the features described herein, the storage machine holds instructions executable by the logic machine to: present the recording of the game event for community feedback, re-train the machine-learning analyzer using the recording of the game event in response to the recording of the game event being deemed popular based on community feedback. In one example implementation that optionally may be combined with any of the features described herein, the storage machine holds instructions executable by the logic machine to: send, to the client computing device, a command to provide a reward in response to the recording of the game event being determined to be an event of interest. In one example implementation that optionally may be combined with any of the features described herein, the first perspective is a first person perspective of a virtual environment, and the second perspective is a third-person perspective of the virtual environment. In one example implementation that optionally may be combined with any of the features described herein, the first perspective is a first virtual camera angle of a virtual environment, and the second perspective is a second camera angle of the virtual environment different than the first camera angle. In one example implementation that optionally may be combined with any of the features described herein, the first perspective follows a virtual avatar of a game player throughout a virtual environment, and the second perspective follows an object of interest throughout the virtual environment.

In another example implementation, on a service computing system, a method for recording a game event includes receiving, from a client computing device, game data representing a game event generated during gameplay of a video game on the client computing device, the game event visually presented from a first perspective during gameplay of the video game on the client computing device, providing the game data as input to a machine-learning analyzer to determine whether the game event is an event of interest, the machine-learning analyzer previously-trained using previously-recorded game events deemed popular based on community feedback, the machine-learning analyzer determining that the game event is an event of interest based on the game event having characteristics that match characteristics of the previously-recorded game events deemed popular, and generating a recording of the game event based on the game data in response to the machine-learning analyzer determining that the game event is an event of interest, the recording of the game event having a second perspective different than the first perspective. In one example implementation that optionally may be combined with any of the features described herein, the method further includes presenting the recording of the game event for community feedback, and re-training the machine-learning analyzer using the recording of the game event in response to the recording of the game event being deemed popular based on community feedback. In one example implementation that optionally may be combined with any of the features described herein, the method further includes sending, to the client computing device, a command to provide a reward in response to the recording of the game event being determined to be an event of interest.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a service computing system, a method for recording a game event, the method comprising:
receiving, from a client computing device, game data representing a game event generated during gameplay of a video game on the client computing device;
providing the game data as input to a machine-learning analyzer to determine whether the game event is an event of interest, the machine-learning analyzer previously-trained using previously-recorded game events deemed popular based on community feedback, the machine-learning analyzer determining that the game event is an event of interest based on the game event having characteristics that match characteristics of the previously-recorded game events deemed popular; and
issuing a command to generate a recording of the game event in response to the machine-learning analyzer determining that the game event is an event of interest.

2. The method of claim 1, wherein the machine-learning analyzer is previously trained using previously-recorded game events deemed not popular based on community feedback.

3. The method of claim 1, wherein a previously-recorded game event is deemed popular in response to the previously-recorded game event exceeding a community popularity threshold.

4. The method of claim 3, wherein the community popularity threshold includes a threshold number of times a recording of the previously-recorded game event is viewed by community members.

5. The method of claim 3, wherein the community popularity threshold includes a threshold number of affirmations of a recording of the previously-recorded game event by community members.

6. The method of claims 3, wherein the community popularity threshold includes a threshold number of recommendations of a recording of the previously-recorded game event by community members.

7. The method of claim 1, further comprising:
presenting the recording of the game event for community feedback; and
re-training the machine-learning analyzer using the game event in response to the recording of the game event being deemed popular based on community feedback.

8. The method of claim 7, further comprising:
sending, to the client computing device, a command to provide a reward in response to the recording of the game event being determined to be an event of interest.

9. The method of claim 1, further comprising:
receiving biometric data of a game player of the video game, the biometric data captured during generation of the game event during gameplay of the video game; and
providing the biometric data as input to the machine-learning analyzer to determine whether the game event is an event of interest, the machine-learning analyzer previously-trained using biometric data of game players during generation of previously-recorded game events, the machine-learning analyzer determining that the game event is an event of interest based on the game player having biometric characteristics that match biometric characteristics of game players during generation of the previously-recorded game events.

10. A service computing system, comprising:
a logic machine; and
a storage machine holding instructions executable by the logic machine to:
receive, from a client computing device, game data representing a game event generated during gameplay of a video game on the client computing device, the game event visually presented from a first perspective during gameplay of the video game on the client computing device;
provide the game data as input to a machine-learning analyzer to determine whether the game event is an event of interest; and
generate a recording of the game event based on the game data in response to the machine-learning analyzer determining that the game event is an event of interest, the recording of the game event having a second perspective different than the first perspective.

11. The service computing system of claim 10, wherein the machine-learning analyzer is previously-trained using previously-recorded game events deemed popular based on community feedback, and wherein the machine-learning analyzer is configured to determine that the game event is an event of interest based on the game event having characteristics that match characteristics of the previously-recorded game events deemed popular.

12. The service computing system of claim 11, wherein a previously-recorded game event is deemed popular in response to the previously-recorded game event exceeding a community popularity threshold.

13. The service computing system of claim 11, wherein the storage machine holds instructions executable by the logic machine to:
present the recording of the game event for community feedback;
re-train the machine-learning analyzer using the recording of the game event in response to the recording of the game event being deemed popular based on community feedback.

14. The service computing system of claim 13, wherein the storage machine holds instructions executable by the logic machine to:
send, to the client computing device, a command to provide a reward in response to the recording of the game event being determined to be an event of interest.

15. The service computing system of claim 10, wherein the first perspective is a first person perspective of a virtual environment, and wherein the second perspective is a third-person perspective of the virtual environment.

16. The service computing system of claim 10, wherein the first perspective is a first virtual camera angle of a virtual environment, and wherein the second perspective is a second camera angle of the virtual environment different than the first camera angle.

17. The service computing system of claim 10, wherein the first perspective follows a virtual avatar of a game player throughout a virtual environment, and wherein the second perspective follows an object of interest throughout the virtual environment.

18. On a service computing system, a method for recording a game event, the method comprising:
receiving, from a client computing device, game data representing a game event generated during gameplay of a video game on the client computing device, the game event visually presented from a first perspective during gameplay of the video game on the client computing device;
providing the game data as input to a machine-learning analyzer to determine whether the game event is an event of interest, the machine-learning analyzer previously-trained using previously-recorded game events deemed popular based on community feedback, the machine-learning analyzer determining that the game event is an event of interest based on the game event having characteristics that match characteristics of the previously-recorded game events deemed popular; and
generating a recording of the game event based on the game data in response to the machine-learning analyzer determining that the game event is an event of interest, the recording of the game event having a second perspective different than the first perspective.

19. The method of claim 18, further comprising:
presenting the recording of the game event for community feedback; and
re-training the machine-learning analyzer using the recording of the game event in response to the recording of the game event being deemed popular based on community feedback.

20. The method of claim 19, further comprising:
sending, to the client computing device, a command to provide a reward in response to the recording of the game event being determined to be an event of interest.
